(19) United States
(12) Patent Application Publication
(10) Pub. No.: US 2010/0112315 A1
(43) Pub. Date: May 6, 2010

(54) LAMINATING FILM AND METHODS OF USE THEREOF

(75) Inventors: Guiqin Song, Milton (CA); T. Brian McAneney, Burlington (CA); Nan-Xing Hu, Oakville (CA); Michael J. Sculley, Webster, NY (US)

Correspondence Address: PILLSBURY WINTHROP SHAW PITTMAN, LLP;XEROX CORPORATION, P.O. BOX 10500, MCLEAN, VA, 22102, US

(73) Assignee: XEROX CORPORATION, Norwalk, CT (US)

(21) Appl. No.: 12/263,258

(22) Filed: Oct. 31, 2008

(51) Int. Cl. B32B 3/10; B32B 33/00; B32B 27/30; B32B 37/12; B32B 27/00

(52) U.S. Cl. 428/200; 428/355 R; 428/349; 428/355 EN; 428/355 N; 428/195.1; 428/201; 156/60

(57) ABSTRACT

A laminating film and methods of use with xerographic prints. The laminating film comprises an adhesion promoter comprising a hydrolytic silane compound that imparts improved adhesion and which can be used in laminating applications conducted at high and as well as low temperature ranges.

### BACKGROUND

The present disclosure generally relates to a laminating film and methods of use with xerographic prints. The laminating film comprises an adhesion promoter comprising a hydrolytic silane compound that imparts improved adhesion and which can be used in laminating applications conducted at high as well as low temperature ranges.

In imaging devices, a light image of an original to be copied is recorded in the form of a latent image upon a photosensitive member, and the latent image is subsequently rendered visible by the application of resin particles and pigment particles, or toner. The visible toner image is then in a loose powdered form and can be easily disturbed or destroyed. The toner image may be fixed or fused upon a support, which may be a support sheet such as plain paper, using a fuser roll.

To ensure and maintain good release properties of the fuser roll, it has become customary to apply release agents to the fuser roll during the fusing operation. These materials are applied as thin films of, for example, nonfunctional silicone oils or mercapto- or amino-functional silicone oils, to prevent toner offset.

U.S. Pat. No. 4,029,827 discloses the use of polyorganosiloxanes having mercapto functionality as release agents. U.S. Pat. No. 4,101,686 and U.S. Pat. No. 4,185,140 disclose polymeric release agents having functional groups such as carboxy, hydroxy, epoxy, amino, isocyanate, thioether, or mercapto groups. U.S. Pat. No. 5,157,445 discloses toner release oil having a functional organopolysiloxane.

Fuser oil unavoidably contaminates the surface of prints during xerographic printing process. Because the fuser oil is chemically bound on the paper surface during the hot fusing process, especially for example with mercapto or amino functionalized fuser oil, it may be difficult to wipe off the fuser oil, and the surface free energy (SFE) of the xerographic prints is significantly lowered because of the oil contamination and thus causes poor binding between the adhesive and prints.

Xerographic prints sometimes need to be laminated with PET, PP, PE or PVC films. One additional layer of polymeric materials such as thermoplastic EVA copolymer resin is extrusion coated onto these films. U.S. Pat. No. 7,368,165 discloses the process for the production of coated polymeric film. U.S. Pat. No. 7,323,239 discloses protective films coated with EVA copolymer. U.S. Pat. No. 6,645,336 discloses the extrusion coating process for making these thermal plastic polymeric materials coated films. U.S. Pat. No. 4,234,644 discloses the composite lamination film for electrophoretically toned images

### SUMMARY

According to embodiments illustrated herein, there is provided an improved laminating film and methods of use with xerographic prints.

In one embodiment, there is disclosed a laminating film for laminating xerographic prints, comprising a plastic substrate, and an adhesive coating disposed on a surface of the plastic substrate, wherein the adhesive coating comprises an adhesion promoter comprising a silane coupling component selected from the group consisting of a hydrolytic silane compound, a hydrolytic product of a hydrolytic silane compound, and mixtures thereof.

In another embodiment, there is provided a bonded article, comprising a xerographic print, an adhesive coating disposed on the xerographic print, a laminating film disposed on the adhesive coating, the laminating film comprising a plastic substrate, and an adhesion promoter present at either an interface between the xerographic print and the adhesive coating or within the entire adhesive coating, wherein the adhesion promoter comprises a silane coupling component selected from the group consisting of a hydrolytic silane compound, a hydrolytic product of a hydrolytic silane compound, and mixtures thereof.

In yet another embodiment, there is provided a method for laminating xerographic prints, comprising providing a xerographic print, applying an adhesive coating on the xerographic print, applying a laminating film over the xerographic print, wherein the laminating film comprises a plastic substrate, and an adhesive coating disposed on a surface of the plastic substrate, wherein the adhesive coating comprises an adhesion promoter comprising a hydrolytic silane compound and further wherein the laminating film is applied in a manner such that the xerographic print contacts the adhesive coating on a side opposite that which is disposed on the surface of the plastic substrate, and subjecting the xerographic print and laminating film to heat.

### BRIEF DESCRIPTION OF THE DRAWINGS

For a better understanding, reference may be had to the accompanying figure.

FIG. 1A represents a simplified side view of a laminating film in accordance with a first embodiment of the present embodiments;

FIG. 1B represents a simplified side view of a laminating film in accordance with a second embodiment of the present embodiments; and

FIG. 2 represents a bonded article formed from the laminating methods in accordance with the present embodiments.

Unless otherwise noted, the same reference numeral in different Figures refers to the same or similar feature.

### DETAILED DESCRIPTION

As explained above, it is known to apply release agents to the fuser roll to provide the necessary release of a substrate containing an image thereon from the fuser roll after the toner image has been formed on the substrate. Thus, xerographic prints may be contaminated by a release agent such as silicone fuser oil due to the printing process. Some release agent may remain on a toner image that may cover any portion of the substrate and on the substrate itself. In other words, some release agent may remain on a final substrate having an image thereon and may at least partially cover a substrate having no toner image or a substrate having a toner image thereon. “Partially” refers to the release agent covering from above 0 percent to less than 100 percent of the substrate, such as from about 10 percent to about 90 percent or from about 20 percent to about 80 percent of the substrate. The release agent may chemically bond to the surface of the prints because of the reactive functional group such as amino- or mercapto-functional group in fuser oil during fusing process at high pressure and high temperature. The surface free energy (SFE) of the prints may thus dramatically drop from a range of higher than about 30 mN/m for substrates such as paper to a range of from about 8 mN/m to less than about 30 mN/m. Generally, commercially available hot melt adhesives bind to substrates having a SFE higher than about 30 mN/m.

Any release agent remaining on the substrate, with or without a toner image thereon, may be detrimental to an adhesive attempting to adhere to the substrate having a toner image. This is particularly important when the substrate is to be laminated or coated with a hot melt adhesive, such as an adhesive used in bookbinding. This release agent may also prevent materials utilizing adhesives, for example, POST-IT® notes, from adhering to the substrate.

Release agents used in releasing a substrate from a fuser roll in an imaging device include poly-organofunctional siloxanes, such as amino-functional silicone oils, such as methyl aminopropyl methyl siloxane, ethyl aminopropyl methyl siloxane, benzyl aminopropyl methyl siloxane, dodecyl aminopropyl methyl siloxane, aminopropyl methyl siloxane, and the like.

Disclosed in U.S. application Ser. No. 11/743,447, and US Publication Nos. 2008/0171826 and 2008/0071043, are adhesion promoters that promote the adhesion of an adhesive to a substrate with low surface free energy. However, those adhesion promoters are directed to applications involving adhesives used directly on traditional paper substrates, for example, in bookbinding applications.

Synthetic media made of specially treated plastic films are being increasingly used for printing applications where moisture and/or contamination would damage traditional paper substrates. Such plastic substrates are durable and tear resistant, and are finding increasing use in labels, tags, maps, menus, posters, manuals, books, covers, and various cards such as identification cards, gift cards, credit cards, hotel key cards, and the like. The use of such material technology is rapidly growing and replacing traditional paper substrates.

As discussed above, poor adhesion issues are often encountered for xerographic prints on traditional paper substrates due to fuser oil contamination. In cases involving plastic substrates, such as gift cards, credit cards or hotel key cards, there is an added complication in that xerographic prints printed on the synthetic papers have to be laminated together with films such as polyester, including polyethylene terephthalate (PET) film which may be pre-coated with ethylene vinyl acetate (EVA) adhesive. Poor adhesion is also encountered when the films are laminated together with the xerographic prints printed on synthetic paper because of the residual fuser oil contamination. Thus, there is a need for adhesion promoters and methods of use that can facilitate adequate adhesion for plastic substrates, and also be used in laminating methods at various temperature ranges.

Disclosed herein is the incorporation of the silane promoters into a laminating film as well as an improved laminating method for plastic substrates with xerographic printed synthetic media. The embodiments disclosed herein have demonstrated dramatically improved adhesion for the laminating application. The use of the specific adhesion promoters, comprising a hydrolytic silane compound, promotes and dramatically improves adhesion between the synthetic media and the laminating material. The silane adhesion promoters can be implemented by different manners, including use as a primer either on pre-coated adhesive films or on xerographic printed synthetic media, or incorporated into an adhesive coating. Specific types of silane promoter are also disclosed for laminating methods at high temperature.

As used herein, and without any indication to the contrary, “synthetic media” or “substrate” refers to plastic substrates, such as without limitation, polyethylene, polypropylene, poly(vinyl chloride) (PVC), Polyester (PET) and mixtures thereof.

The substrate may be at least partially covered by a release agent. The adhesion promoter may also promote adhesion of an adhesive to a substrate having no toner image or a substrate having a toner image without being covered by a release agent.

It is desirable to have an adhesive with a stable viscosity that is maintained constant during the application process. For example, the adhesive desirably has a stable viscosity at the application temperature, such as a temperature from about 100° C. to 200° C., such as from about 140° C. to about 190° C. or from about 150° C. to about 180° C.

An adhesive that incorporates a conventional adhesion promoter may encounter pot life issue. That is, the viscosity of the adhesive may not be able to be kept constant long enough in a hot pot to meet the requirements during the extrusion coating process for the laminating film preparation process. The viscosity of the adhesive containing a conventional adhesion promoter may continuously increase and cause operating problems. This can be especially problematic at high extrusion coating temperature during the laminating film preparation process.

It is thus desirable to have an adhesion promoter that can be added to thermalplastic resin such as EVA copolymer, or hot melt adhesive or pressure sensitive adhesive and at the same time maintain the thermal stability of the adhesive, or maintain a long enough pot life and constant viscosity of the adhesive during the application process.

A thermally stable adhesive is one that substantially maintains its viscosity and adhesion properties over a period of time. A stable viscosity, for example, is an increase or decrease in viscosity within 1000 cp over the aging process at the application temperature, such as from about 100 to about 800 cp over 8 hours at an application temperature or from about 200 to about 600 cp over 8 hours at an application temperature.

In embodiments, the adhesion promoter before treatment may be a silane compound, for example, a silane compound such as an alkyloxysilane compound or a glycidoxy silane compound. Further examples include organic silane compounds, which may be represented by the following formula:

—Si(R)3-mXm

wherein R is a C₁-C₃₀ hydrocarbyl including an alkyl, an aryl, a vinyl and the like, wherein said hydrocarbyl may further contain a halogen, nitrogen, oxygen or sulfur atom. Illustrative examples of R may include methyl, ethyl, propyl, octyl, phenyl, methacryloxypropyl, aminopropyl, aminoethylaminopropyl, phenylaminopropyl, chloropropyl, mercaptopropyl, acryloxypropyl, 3-glycidoxypropyl, trifluoropropyl, heptadecafluorodecyl, and isocyanatopropyl group and the like. X may represent a hydrolyzable functional group, a C₁-C₂₀ alkoxy group, a halogen or a hydrogen atom, and m is an integer of 1, 2 or 3.

In embodiments, R may be a non-hydrolyzable organic group, X may be a hydrolytic group and m may be an integer of 1, 2 or 3. X may include a halide, a hydroxyl group, a carboxylate group, an alkoxy group, an arylalkyloxy group and an aryloxy group. The hydrolytic silane compound may contain in total two of the hydrolytic X group

In embodiments, the hydrolytic silane compound may include a functional group. Examples of functional groups may include, for example but not limited to, an amino group, a mercapto group, an epoxy group and a vinyl group.

Examples of silane compounds suitable for use herein include aminoalkylsilane, mercaptoalkylsilane and mixtures thereof, for example, 4-aminobutyltriethoxysilane, 1-amino-2-(dimethylethoxysilyl)propane, N-(2-aminoethyl)-3-aminoisobutyldimethylmethoxysilane, N-(2-aminoethyl)-3-aminoisobutyldimethylmethoxysilane, (aminoethylaminomethyl)phenethyltrimethoxysilane, N-(2-aminoethyl)-3-aminopropylmethyldimethoxysilane, N-(2-aminoethyl)-3-aminopropylsilanetriol, N-(2-aminoethyl)-3-aminopropyltriethoxysilane, N-(2-aminoethyl)-3-aminopropyltrimethoxysilane, N-aminoethyl-AZA-2,2,4-trimethylsilacyclopentane, N-(6-aminohexyl)aminomethyl-trimethoxysilane, N-(6-aminohexyl)aminopropyl-trimethoxysilane, N-(2-aminoethyl)-11-aminoundecyl-trimethoxysilane, 3-aminopropylmethylbis(trimethylsiloxy)silane, 3-aminopropyldimethylethoxysilane, 3-aminopropyltrimethoxysilane, 3-aminopropyltris(methoxyethoxyethoxy)silane, 3-(triethoxysilyl)propylsuccinic anhydride, tris(3-trimethoxysilylpropyl)iso-cyanurate, (3-trimethoxysilylpropyl)diethylene-triamine, methyltrichlorosilane, dimethyldichlorosilane, methyltriethoxysilane, ethyltrichlorosilane, ethyltrimethoxysilane, dimethyldimethoxysilane, methyltriethoxysilane, ethyltriethoxysilane, propyltrimethoxysilane, amino silane hydrochloride, 3-glycidoxypropyl trimethoxysilane (Z-6040, available from Dow Coming; KBM 403, available from Shin-Etsu), methyltrimethoxysilane (Z-6070, available from Dow Coming; KBM 13, available from Shin-Etsu), methacryloxypropyltrimethoxysilane (Z-6030, available from Dow Coming; KBM502, available from Shin-Etsu), aminopropyltrimethoxysilane (Z-6011, available from Dow Coming; KBM903, available from Shin-Etsu), aminoethylaminopropyltrimethoxysilane (KBM603, available from Shin-Etsu or DOW Z 6032, available from Dow Coming; KBM603, available from Shin-Etsu), trifluoropropyltrimethoxysilane (KBM7103, available from Shin-Etsu), heptadecafluorodecyltrimethoxysilane (KBM7803, available from Shin-Etsu), isocyanatopropyltriethoxysilane (KBE9007, available from Shin-Etsu), aminopropyltriethoxysilane (KBE903, available from Shin-Etsu), aminoethylaminopropyltriethoxysilane (KBE603, available from Shin-Etsu), alkyltrimethoxysilane (DOW HV 10, available from Dow Korning), and a coating having trifluoropropy trimethoxysilane, vinylmethoxysilane, tetra(2-methoxyethoxy)silane (DOW 4040 Prime Coat, available from Dow Corning), mixtures thereof, and the like.

The adhesion promoter disclosed herein may include more than one silane compound, for example, the adhesion promoter may include from 1 to about 5 silane compounds, such as from 1 to 3 silanes

In embodiments, the silane compound is admixed with aqueous buffer solution before incorporation into an adhesive. The aqueous buffer solution may include a buffer agent. The aqueous buffer solution is made by dissolving the buffer agent into distilled water. The buffer agent may be an inorganic salt, for example an alkali metal phosphate, an alkali metal sulfite and the like or an aqueous solution of an inorganic salt. Other suitable buffer agents include aqueous solutions of potassium phosphate monobasic, potassium phosphate dibasic, sodium hydrogen sulfite, mixtures thereof and the like, for example dissolved in distilled water.

In embodiments, the aqueous buffer solution may be prepared to form from about 1% to about 50% by weight buffer solution, such as, from about 5% to about 25% by weight buffer solution, and for example from about 5% to about 15% by weight buffer solution.

In embodiments, the pH of the buffer solution may be, for example, from about 2 to about 10, such as from about 4 to about 9.

In embodiments, the aqueous buffer solution may be added to the silane compound, for example in a silane to buffer solution ratio from 1:0.005 to 1:0.5, such as a ratio of 1:0.15 and for example a ratio of 1:0.35. The buffer solution may be added to the silane compound while agitating the silane compound at room temperature. The silane compound temperature goes up after the adding of the buffer solution because this may be an exothermic reaction process. The adhesion promoter may be kept agitating from about 1 hour to about 3 hours before it is incorporated into hot melt adhesives or pressure sensitive adhesives. The shelf life for the admixed silane may be as long as three days or longer at room temperature.

The admixed silane adhesion promoter described herein provides at least two beneficial functions in order to promote adhesion of the adhesive to the substrate: (1) a reactive silicone group, that is, a group reactive with silicone, for bonding with the Xerographic print or substrate, such as a methoxy or an ethoxy group, and (2) an organic component for compatibility with the adhesive.

The admixed silane adhesion promoter described herein may provide at least two beneficial functions in order to promote adhesion of the adhesive to the substrate: (1) a reactive silicone group, that is, a group reactive with silicone, for bonding with the xerographic print or substrate, such as a methoxy or an ethoxy group, and (2) an organic component for compatibility with the adhesive.

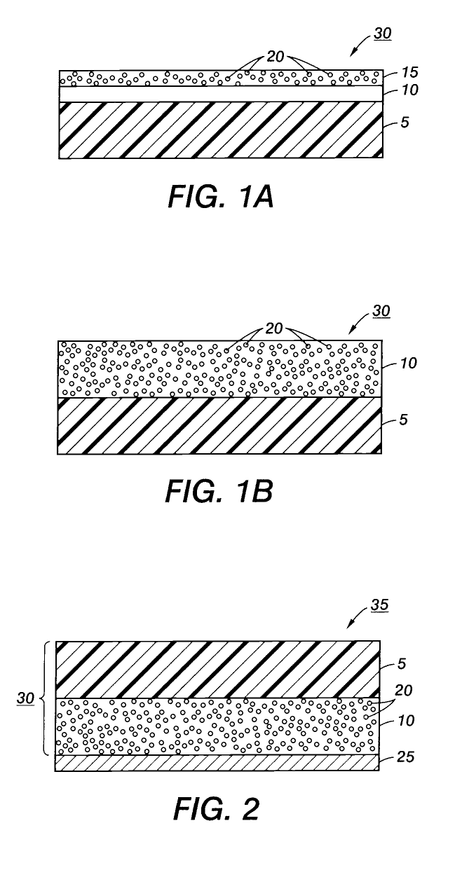

The admixed adhesion promoter may be utilized in a variety of ways to promote the adhesion of an adhesive to a substrate. In embodiments, the admixed adhesion promoter may be used as a separate coating on the substrate or an adhesive coating to be used as a primer, dispersed within a release agent, or incorporated into an adhesive. In FIG. 1A, there is depicted a laminating film 30 for laminating xerographic prints which comprises a plastic substrate 5, and an adhesive coating 10 disposed on a surface of the substrate 5. The adhesive coating 10 further comprises an adhesion promoter comprising a hydrolytic silane compound 20. The plastic substrate 5 may be selected from the group consisting of polyethylene, polypropylene, poly(vinyl chloride) and mixtures thereof. In FIG. 1A, the adhesion promoter is incorporated along a surface of the adhesive coating 10 as a primer layer 15. In another embodiment, depicted in FIG. 1B, the adhesion promoter 20 is incorporated into the adhesive coating 10. The adhesive coating may have a thickness of from about 10 microns to about 200 microns. The plastic substrate may have a thickness of from about 50 microns to about 500 microns. The xerographic prints may be from about 100 microns to about 500 microns.

In FIG. 2, there is depicted a bonded article 35 formed by the laminating methods described herein. The bonded article 35 comprises a xerographic print 25, and a laminating film 30 for laminating xerographic prints. The laminating film 30 comprises a plastic substrate 5 and an adhesive coating 10 disposed on a surface of the substrate 5, which further comprises an adhesion promoter comprising a hydrolytic silane compound 20. The hydrolytic silane compound can be selected, for example, from the group consisting of an aminoalkylsilane, a mercaptoalkylsilane or mixtures thereof.

In the present embodiments, there is provided laminating methods for xerographic prints which can be used in both low temperature applications (e.g., <100° C.) and high temperature applications (e.g., >=100° C.). The method comprises providing a xerographic print to be laminated, and applying a laminating film over the xerographic print. The laminating film comprises a plastic substrate, and an adhesive coating disposed on a surface of the substrate so that the adhesive coating will bind the plastic substrate to the xerographic print. The adhesive coating further comprises an adhesion promoter comprising a hydrolytic silane compound.

As discussed above, poor adhesion issues are often encountered for the xerographic prints printed on the traditional paper due to amino functional fuser oil contamination. Because the fuser oil is chemically bound on the paper surface during hot fusing process, the surface free energy of the prints is significantly lowered and this causes the poor adhesion problem. The same problems are encountered for synthetic media as demonstrated in Tables 1 and 2. Table 1 demonstrates how the surface free energy is lowered after the synthetic media is run through a XEROX® IGEN3® printer with amino fuser oil (available from Wacker Chemical Corporation, Adrian, Mich.) with and without toner on the surface. Artisyn, Teslin and Dura paper are all synthetic papers which are commercial available on market. All grades of Teslin® synthetic printing sheet are continuous, homogeneous materials composed of polyethylene and inert fillers formed into a sheet with a microporous void structure. Xerox Digital Color DuraPaper is a heavyweight synthetic media and specially coated with 4 mil polyester to resist tearing, smudging and deterioration

TABLE 1

| | SFE (mN/m) at 10 seconds | | |
|---|---|---|---|
| Substrate Description | 12 pt Artisyn | 14 pt Teslin | 14 pt Dura |
| Original - No Oil | 45.32 | 45.08 | 41.63 |
| No Toner - Fuser | 19.18 | 34.48 | 31.00 |
| Fluid I | | | |
| Solid Black Toner - | 23.23 | 23.66 | 22.69 |
| Fuser Fluid I | | | |

Table 2 demonstrates the reduction in surface free energy of poly(vinyl chloride) films after being run through a XEROX® IGEN3® printer with amino fuser oil with and without toner on the surface.

TABLE 2

| | SFE (mN/m) at 10 seconds | | |
|---|---|---|---|
| Substrate Description | 10 mil PVC | 13 mil PVC | 26 mil PVC |
| Original - No Oil | 42.24 | 42.82 | 44.80 |
| No Toner - Fuser | 31.13 | 30.60 | 32.18 |
| Fluid I | | | |
| Solid Black - Fuser | 27.35 | 29.22 | 29.28 |
| Fluid I | | | |

The present embodiments disclose three approaches to improve the adhesion on xerographic prints printed on synthetic media laminated with films such as polyester, polyethylene and polypropylene films which are pre-coated with adhesives such as EVA-based copolymers. One approach is to use amino- or mercapto-functional silane as a primer to apply either on the laminating films or on xerographic synthetic prints to improve the laminating adhesion. The second approach is to incorporate amino- or mercapto-functional silane with adhesives, such as for example, EVA-base adhesives, before the adhesive is coated on a film, for example, polyester films. This second approach is useful for low temperature laminating methods. The third approach is to incorporate pre-treated amino- or mercapto-functional silane with adhesives, such as for example, EVA-base adhesives, before the adhesive is coated on a film, for example, polyester films. The silane compound may be pre-treated by using buffer solutions such as a potassium phosphate monobasic aqueous solution. This third approach is useful for high temperature laminating methods.

Suitable hot melt adhesives for use herein include most commercially available hot melt adhesive, such as polyethylene, poly(ethylene/vinyl acetate), polystyrene, polyamide, a polyolefin based polymer, polyester, phenol-formaldehyde resin, etc., of a homopolymer or a block copolymer based hot melt adhesives and thermal plastic resins such as EVA copolymers

When the admixed silane compound used as an adhesion promoter is added to a commercially available hot melt adhesive or the thermal plastic resin, for example EVA copolymers, the first step is to heat the adhesive or the thermal plastic resin to the application temperature until the adhesive or the thermal plastic resin is substantially melted or flows. Then the adhesion promoter is slowly added to the adhesive while keeping the application temperature and the speed of the agitation controlled. The application temperature is determined by the viscosity of the adhesive.

The adhesion promoter may be added to the adhesive formulation in amounts of from about 0.05 weight percent to about 5 weight percent of the base adhesive, such as from about 0.5 weight percent to about 3 weight percent or from about 1 weight percent to about 2 weight percent of the adhesive formulation.

By chemically bonding to both the adhesive and the substrate, the pretreated adhesion promoter promotes the adhesion of an adhesive to a substrate having an oil contaminated surface with a Surface Free Energy (SFE) from less than about 30 mN/m, such as from about 8 mN/m to less than about 30 mN/m, such as from about 10 mN/m to about 28 mN/m or from about 15 mN/m to about 25 mN/m.

In embodiments, the adhesive may display a viscosity ranging for example from about 1,000 centipose to about 20,000 centipose at temperatures ranging for example from about 120° C. to about 200° C.

Suitable hot melt adhesives for use herein may include thermoplastics or materials which appear to be thermoplastic including components such as polymer resins, tackifiers, waxes, plasticizers, antioxidants and filler or combinations thereof.

The most commonly used hot melt adhesive is based on ethylene vinyl acetate (EVA) resins. Other polymers commonly used in hot melt adhesives and pressure sensitive adhesives include low density polyethylene, poly(ethylene/vinyl acetate), polyvinyl alcohol, polystyrene, polyamides, polyalkylene oxide, polyacrylate, ethylene acrylic copolymers, polypropylene(atactic), phenoxy resins, polyesters, APAO, polyesteramides, polyparaffins, polyurethanes, polyurethane prepolymers, thermalplastic acrylic polymers butyl rubbers, polyvinyl acetate and copolymers, styrenic block copolymers (SIS, SBS, SEBS), phenol-formaldehyde resin of polymer or block copolymer, natural rubber, and a copolymer thereof etc.

Examples of suitable polymer resins that may be optionally used for laminating films can be pure copolymer. For example EVA polymer having different melt index with different VA grades such as 18% and 28% VA grades.

Other polymers that can be used in laminating films include poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene) and poly(butyl acrylate-isoprene), poly(styrene-butadiene), poly(methylstyrene-butadiene), poly(styrene-isoprene), poly(methylstyrene-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), and poly(styrene-butyl acrylate-acrylononitrile-acrylic acid), block copolymer such as styrene-isoprene-styrene (SIS) or styrene-butadiene-styrene (SBS), polyester or mixtures thereof and the like. In embodiments, the polymer resin content in the hot melt adhesives or pressure sensitive adhesives may be in the amount of from about 20 to about 100% by weight, such as from about 25 to about 90% by weight.

Examples of optional tackifiers used in hot melt adhesives and pressure hydrocarbons or mixed C5/C9 resins, modified rosin, natural tackifiers are rosin acid derivatives and their esters, terpene resins, pure monomers, hydrogenated pure monomers etc. and combinations thereof Examples of the optional tackifier suitable for use herein may be Eastotac H100-W, Regalite S1100, Foralyn 110 from Eastman Chemical. In embodiments, the optional tackifier may be added to the adhesive, for example, in the amount of from about 5 to about 30% by weight.

Examples of the optional wax suitable for use herein may include natural and synthetic waxes. Examples of natural waxes may include animal wax such as beeswax and lanolin wax, vegetable wax such as carnauba wax, mineral wax such as montan wax and paraffin wax, microcrystalline wax and slack wax. Examples of synthetic waxes suitable for used herein may include polyethylene wax such as homopolymer wax and copolymer wax and modified polymer wax, polypropylene wax such as homopolymer wax and modified polymer wax, semicrystalline flexible polyolefines, and Fisher-Tropsch wax such as homopolymer wax and modified polymer wax. In embodiments, the optional wax may be added to the adhesive, for example, in the amount of from about 5 to about 20% by weight. In embodiments, the wax may have a melting point for example from about 50° C. to about 150° C.

Examples of the optional antioxidant suitable for use herein include primary and secondary antioxidant or multifunctional antioxidant, hydroxylamines, N,N′-hexamethylene bis(3,5-di-tert-butyl-4-hydroxy hydrocinnamamide) (IRGANOX 1098, available from Ciba-Geigy Corporation), 2,2-bis(4-(2-(3,5-di-tert-butyl-4-hydroxyhydrocinnamoyloxy))ethoxyphenyl)propane (TOPANOL-205, available from ICI America Corporation), tris(4-tert-butyl-3-hydroxy-2,6-dimethyl benzyl)isocyanurate (CYANOX 1790, 41,322-4, LTDP, Aldrich D12,840-6), 2,2′-ethylidene bis(4,6-di-tert-butylphenyl)fluoro phosphonite (ETHANOX-398, available from Ethyl Corporation), tetrakis(2,4-di-tert-butylphenyl)-4,4′-biphenyl diphosphonite (ALDRICH 46,852-5; hardness value 90), pentaerythritol tetrastearate (TCI America #PO739), tributylammonium hypophosphite (Aldrich 42,009-3), 2,6-di-tert-butyl-4-methoxyphenol (Aldrich 25,106-2), 2,4-di-tert-butyl-6-(4-methoxybenzyl)phenol (Aldrich 23,008-1), 4-bromo-2,6-dimethylphenol (Aldrich 34,951-8), 4-bromo-3,5-didimethylphenol (Aldrich B6,420-2), 4-bromo-2-nitrophenol (Aldrich 30,987-7), 4-(diethyl aminomethyl)-2,5-dimethylphenol (Aldrich 14,668-4), 3-dimethylaminophenol (Aldrich D14,400-2), 2-amino-4-tert-amylphenol (Aldrich 41,258-9), 2,6-bis(hydroxymethyl)-p-cresol (Aldrich 22,752-8), 2,2′-methylenediphenol (Aldrich B4,680-8), 5-(diethylamino)-2-nitrosophenol (Aldrich 26,951-4), 2,6-dichloro-4-fluorophenol (Aldrich 28,435-1), 2,6-dibromo fluoro phenol (Aldrich 26,003-7), α-trifluoro-o-cresol (Aldrich 21,979-7), 2-bromo-4-fluorophenol (Aldrich 30,246-5), 4-fluorophenol (Aldrich F1,320-7), 4-chlorophenyl-2-chloro-1,1,2-tri-fluoroethyl sulfone (Aldrich 13,823-1), 3,4-difluoro phenylacetic acid (Aldrich 29,043-2), 3-fluorophenylacetic acid (Aldrich 24,804-5), 3,5-difluoro phenylacetic acid (Aldrich 29,044-0), 2-fluorophenylacetic acid (Aldrich 20,894-9), 2,5-bis(trifluoromethyl)benzoic acid (Aldrich 32,527-9), ethyl-2-(4-(4-(trifluoromethyl)phenoxy)phenoxy)propionate (Aldrich 25,074-0), tetrakis(2,4-di-tert-butyl phenyl)-4,4′-biphenyl diphosphonite (Aldrich 46,852-5), 4-tert-amyl phenol (Aldrich 15,384-2), 3-(2H-benzotriazol-2-yl)-4-hydroxy phenethylalcohol (Aldrich 43,071-4), NAUGARD 76, NAUGARD 445, NAUGARD 512, AND NAUGARD 524 (manufactured by Uniroyal Chemical Company), and the like, as well as mixtures thereof.

In embodiments, the optional antioxidant may be added to the adhesive, for example, in the amount of from about 0.1% to about 2%.

Examples of the optional filler suitable for use herein include titanium dioxide, calcium carbonates, zinc oxide, clays, talcs and barium sulfate.

In embodiments, the optional filler may be added to the adhesive, for example, in the amount of from about 0.1% to about 5%.

In embodiments, the adhesive may be coated on a plastic substrate, and the adhesion promoter may be present at the interface between the adhesive and the Xerographic prints.

Various exemplary embodiments encompassed herein include a method of imaging which includes generating an electrostatic latent image on an imaging member, developing a latent image, and transferring the developed electrostatic image to a suitable substrate.

While the description above refers to particular embodiments, it will be understood that many modifications may be made without departing from the spirit thereof The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The example set forth herein below and is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

Suitable silane promoters for laminating application between plastic substrate and xerographic printed synthetic media may comprise a hydrolytic silane compound such as N-(2-aminoethyl)-3-aminopropylmethyldimethoxysilane, N-(2-aminoethyl)-3-aminopropyltrimethoxysilane and their derivatives from pre-treatment with buffer solutions.

### Example 1

Xerographic prints printed on synthetic media were generated by using a XEROX® IGEN3® machine. Synthetic papers made of specially treated plastic films are commonly used for printing applications where moisture and/or contamination would damage traditional paper. They are durable and tear resistant, and are finding increasing use in labels, tags, maps, menus, posters, manuals, books, covers, ID and cards such as gift card, credit card and hotel key card etc. This is a rapidly growing niche market in terms of materials (polyethylene, polypropylene, PVC), technology (mono-layer, co-extruded, multi-layer), applications and potential traditional paper replacement. Most synthetic media is manufactured using oil-based synthetic resins (plastics). As a result, synthetic paper possesses characteristics resembling those of plastic film, but looks almost indistinguishable from regular paper. Synthetic paper outperforms regular paper in terms of moisture resistance (almost no structural deterioration or deformation when wet) and durability (resistance to tearing). In addition, it is extremely resistant to chemicals and oils and has an exceptionally smooth surface finish. Amino functional silane was applied on a polyester film which was coated with EVA copolymer. The thickness of the synthetic media can be from 100 microns to around 700 microns and the adhesive coating thickness can be from 1 microns to 200 microns. Two synthetic mediums were laminated with the polyester film. T-peel tests were conducted on these laminated samples by using an INSTRON® tester (available from Instron, Norwood, Mass.) to measure the peel force necessary to separate the two adherents.

Silane adhesion promoter can be applied on the top of the adhesive layer to be used as a primer or incorporated into the adhesives such as EVA copolymer.

For adhesive coating process at high temperature, the silane adhesion promoter may need to be pre-treated in order to get good thermal stability of the adhesive. The silane solution was prepared as follows: 5% silane solution was prepared by adding 2.5 g N-(2-aminoethyl)-3-aminopropyltrimethoxysilane (A-2120) into 45 g Methanol and then adding 2.5 g distilled water. Five laminating conditions were tested on two synthetic mediums: (1) Original paper (No oil, not run through XEROX® IGEN3® machine) laminated with original polyester film; (2) Oiled but no toner paper (the synthetic media was run through XEROX® IGEN3® machine by using Fuser fluid I fuser oil without toner) laminated with original polyester film; (3) Oiled with toner paper (the synthetic media was run through XEROX® IGEN3® machine by using Fuser fluid II fuser oil with solid black toner) laminated with original polyester; (4) Oiled but no toner paper (the synthetic media was run through XEROX® IGEN3® machine by using Fuser fluid I fuser oil without toner) laminated with polyester film coated with adhesion promoter solution by a Meyer Rod coating machine, specifically Meyer Rod #4, (5) Oiled with toner paper (the synthetic media was run through XEROX® IGEN3® machine by using Fuser fluid I fuser oil with solid black toner) laminated with polyester film coated with adhesion promoter solution by Meyer Rod #4.

Laminating samples were prepared as follows: Synthetic media was laminated with 2.65 mil polyester with 7 mil EVA Copolymer with melt index 15 and vinyl acetate (VA) content 16%. KAPTON® tape (high temperature 3M SCOTCH® 5490 with 1 inch width) was used on top of the edge of the polyester film to create one-inch gripping lead edge. A GBC Pouch Laminator (GBC3500 PRO™ SERIES) (available from ACCO Brands Corp., Lincolnshire, Ill.) was used for laminating at a laminating temperature of 150° C. (highest) and a laminating speed of 8 inches/minute (lowest) (Dial Setup 1). The specimen dimension was 15 mm×200 mm.

The T-Peel Test procedure used in the examples followed the ASTM D1876-01 Standard Test Method for Peel Resistance of Adhesives: the INSTRON® load cell was 50N, peel speed was 254 mm/min, and peel length was 300 mm. Five replicates were performed for each measurement and the results of the T-peel force on the synthetic media laminated with polyester film are shown in Table 3.

TABLE 3

| Synthetic Media Condition | 14 pt Dura | 12 pt Artisyn |
|---|---|---|
| No Oil | 12.66 | 48.08 |
| Oil | 7.14 | 37.67 |
| Oil + Solid black toner | 4.93 | 0.78 |
| Oil + A-2120 | 23.24 | 50 |
| Oil + Solid black toner + A- | 12.03 | 9.3 |
| 2120 | | |

### Example 2

Three plastic poly(vinyl chloride) films were printed on XEROX® IGEN3® and then were laminated with polyester film coated with EVA copolymer. T-peel test were conducted on these laminating samples by using an INSTRON® tester. Sample preparation and test procedure are the same as provided in Example 1. The results of the T-peel force on the poly(vinyl chloride) substrate laminated with polyester film are shown in Table 4.

TABLE 4

| PVC | | | Oil + A- | | Oil + Toner + |
|---|---|---|---|---|---|
| Condition | No Oil | Oil | 2120 | Oil + Toner | A-2120 |
| 10 mil PVC | 45 | 7.27 | 45 | 0.39 | 12.18 |
| 13 mil PVC | 45 | 8.77 | 45 | 0.44 | 13.47 |
| 26 mil PVC | 45 | 3.87 | 45 | 0.24 | 13.98 |

Based on the above, it is demonstrated that the bonding between synthetic media and laminating films coated with EVA copolymer can be improved dramatically by using amino functional silane as a primer either on laminating films or on synthetic xerographic prints.

In addition, it is demonstrated that the bonding between synthetic media and laminating films coated with EVA copolymer can be improved dramatically if the amino functional silane is incorporated into the adhesives such as EVA copolymer before the copolymer is coated on the film (e.g., polyester, polyethylene or polypropylene films). Because amino functional silane can dramatically improve the adhesion on EVA-based hot melt adhesives on xerographic prints, such an application is suitable for low temperature (<100° C.) laminating methods.

Lastly, it is further demonstrated that the bonding between synthetic media and laminating films coated with EVA copolymer can be improved dramatically if the amino functional silane is pre-treated by aqueous buffer solution such as potassium phosphate monobasic aqueous solution and then incorporated into the adhesives such as EVA copolymer before the copolymer is coated on the film (e.g., polyester, polyethylene or polypropylene films). Because the pre-treatment of silane by using the buffer solution can dramatically improve the thermal stability of EVA-based hot melt adhesives and also dramatically improve adhesion of the EVA-based hot melt adhesives on xerographic prints, such an application is suitable for high temperature (>=100° C.) laminating methods.

All the patents and applications referred to herein are hereby specifically, and totally incorporated herein by reference in their entirety in the instant specification.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A laminating film for laminating xerographic prints, comprising:
a plastic substrate; and
an adhesive coating disposed on a surface of the plastic substrate, wherein the adhesive coating comprises an adhesion promoter comprising a silane coupling component selected from the group consisting of a hydrolytic silane compound, a hydrolytic product of a hydrolytic silane compound, and mixtures thereof.

2. The laminating film of claim 1, wherein the plastic substrate is selected from the group consisting of polyethylene, polypropylene, poly(vinyl chloride), polyester, and mixtures thereof.

3. The laminating film of claim 1, wherein the adhesive coating is selected from the group consisting of a hot melt adhesive, a pressure sensitive adhesive, and a thermal plastic resin.

4. The laminating film of claim 1, wherein the adhesive coating comprises an ethylene vinyl acetate copolymer resin having vinyl acetate content ranging from 15% to 30%.

5. The laminating film of claim 1, wherein the adhesion promoter is present as a primer at a surface of the adhesive coating.

6. The laminating film of claim 1, wherein the adhesion promoter is present within the entire adhesive coating at a concentration ranging from 0.1% to 5% by weight percent of the total adhesive coating.

7. The laminating film of claim 1, wherein the hydrolytic silane compound is an amino- or mercapto-functional silane compound.

8. The laminating film of claim 1, wherein the silane coupling component comprises the hydrolytic product of a hydrolytic silane compound mixed with an aqueous buffer solution comprising a buffer agent selected from the group consisting of potassium phosphate dibasic, potassium phosphate monobasic, sodium hydrogen sulfite, and mixtures thereof.

9. A bonded article, comprising:
a xerographic print;
an adhesive coating disposed on the xerographic print;
a laminating film disposed on the adhesive coating, the laminating film comprising a plastic substrate; and
an adhesion promoter present at either an interface between the xerographic print and the adhesive coating or within the entire adhesive coating, wherein the adhesion promoter comprises a silane coupling component selected from the group consisting of a hydrolytic silane compound, a hydrolytic product of a hydrolytic silane compound, and mixtures thereof.

10. The bonded article of claim 9, wherein the xerographic print is printed on a substrate selected from the group consisting of a synthetic paper, polyester, polyethylene, polypropylene, poly(vinyl chloride) and mixtures thereof.

11. The bonded article of claim 9, wherein the laminating film is selected from the group consisting of polyethylene, polypropylene, poly(vinyl chloride), polyester, and mixtures thereof.

12. The bonded article of claim 9, wherein the adhesive coating is selected from the group consisting of a hot melt adhesive, a pressure sensitive adhesive, and a thermal plastic resin.

13. The bonded article of claim 9, wherein the hydrolytic silane compound contains at least a silane group of —Si(R)3-mXm, wherein R is an non-hydrolyzable organic group, X is a hydrolytic group, and m is an integer of 1 to 3.

14. The bonded article of claim 9, wherein the promoter is hydrolytic silane compound contains in total two of the hydrolytic X group.

15. The bonded article of claim 9, wherein the hydrolytic silane compound further contains a functional group selected from the group consisting of an amino group, a mercapto group, an epoxy group, and a vinyl group, and mixtures thereof.

16. The bonded article of claim 9, wherein the hydrolytic silane compound is selected from the group consisting of N-(2-aminoethyl)-3-aminopropylmethyldimethoxysilane, N-(2-aminoethyl)-3-aminopropyltrimethoxysilane, N-(2-aminoethyl)-3-aminopropylethyldiethoxysilane, N-(2-aminoethyl)-3-aminopropyltriethoxysilane 4-aminobutyltriethoxysilane, 1-amino-2-(dimethylethoxysilyl)propane, N-(2-aminoethyl)-3-aminoisobutyldimethylmethoxysilane, N-(2-aminoethyl)-3-aminoisobutyldimethylmethoxysilane, (aminoethylaminomethyl)phenethyltrimethoxysilane, N-(2-aminoethyl)-3-aminopropylsilanetriol, N-(6-aminohexyl)aminomethyl-trimethoxysilane, N-(6-aminohexyl)aminopropyl-trimethoxysilane, N-(2-aminoethyl)-11-aminoundecyl-trimethoxysilane, 3-aminopropylmethylbis(trimethylsiloxy)silane, 3-aminopropyldimethylethoxysilane, 3-aminopropyltrimethoxysilane, 3-aminopropyltris(methoxyethoxyethoxy)silane, (3-trimethoxysilylpropyl)diethylene-triamine, and mixtures thereof.

17. The bonded article of claim 9, wherein a silane coupling component comprises the hydrolytic product of a hydrolytic silane compound mixed with an aqueous buffer solution comprising a buffer agent selected from the group consisting of potassium phosphate dibasic, potassium phosphate monobasic, sodium hydrogen sulfite, and mixtures thereof.

18. The bonded article of claim 9, wherein the adhesion promoter is present within the entire adhesive layer at a concentration ranging from 0.1% to 5% by weight percent of the total adhesive.

19. A method for laminating xerographic prints, comprising:
providing a xerographic print;
applying an adhesive coating on the xerographic print;
applying a laminating film over the xerographic print, wherein the laminating film comprises
a plastic substrate, and
an adhesive coating disposed on a surface of the plastic substrate, wherein the adhesive coating comprises an adhesion promoter comprising a hydrolytic silane compound and further wherein the laminating film is applied in a manner such that the xerographic print contacts the adhesive coating on a side opposite that which is disposed on the surface of the plastic substrate; and
subjecting the xerographic print and laminating film to heat.

20. The method of claim 19 further including subjecting the xerographic print and laminating film to pressure.
